(19) United States
(12) Patent Application Publication
(10) Pub. No.: US 2017/0044925 A1
(43) Pub. Date: Feb. 16, 2017

(54) TURBOCHARGER TURBINE WITH VARIABLE NOZZLE

(71) Applicant: BorgWarner Inc., Auburn Hills, MI (US)

(72) Inventors: STEVEN MYERS, OXFORD, MI (US); ANDREW SHUBNELL, ROCHESTER HILLS, MI (US)

(21) Appl. No.: 15/305,252

(22) PCT Filed: Apr. 8, 2015
(86) PCT No.: PCT/US2015/024859

§ 371 Date: Oct. 19, 2016

Related U.S. Application Data
(60) Provisional application No. 61/982,484, filed on Apr. 22, 2014.

(51) Int. Cl. F01D 17/14; F01D 9/04; F02B 37/24

(52) U.S. Cl. CPC F01D 17/143; F02B 37/24; F01D 9/048; F05D 2220/40; F05D 2240/14

(57) ABSTRACT

An exhaust gas turbocharger (1) includes a turbine section (2) having a turbine housing (11) and a turbine wheel (4) disposed in the turbine housing (11). The turbine housing (11) defines a fluid inlet (13), a fluid outlet (10), and a volute (9) that receives fluid from the fluid inlet (13). The turbine wheel (4) is disposed in the turbine housing (11) between the volute (9) and the fluid outlet (10). In addition, a radially-extending nozzle (20) is defined between a working surface (34) of an adjustable nozzle ring (32) and a facing surface (11b) of the turbine housing (11). An inner peripheral edge (40) of the nozzle ring (32) is movable in an axial direction relative to an outer peripheral edge (38) of the nozzle ring (32), whereby the nozzle dimensions can be varied.

### CROSS-REFERENCE TO RELATED APPLICATIONS

This application claims priority to and all the benefits of U.S. Provisional Application No. 61/982,484, filed on Apr. 22, 2014, and entitled “Turbocharger Turbine With Variable Nozzle,” which is incorporated herein by reference.

### BACKGROUND

1. Field of the Invention

The present invention relates to a turbocharger in which the turbine stage includes a variable nozzle.

2. Description of Related Art

A turbocharger is a type of forced induction system used with internal combustion engines. Turbochargers deliver compressed air to an engine intake, allowing more fuel to be combusted, thus boosting an engine's horsepower without significantly increasing engine weight. Thus, turbochargers permit the use of smaller engines that develop the same amount of horsepower as larger, normally aspirated engines. Using a smaller engine in a vehicle has the desired effect of decreasing the mass of the vehicle, increasing performance, and enhancing fuel economy. Moreover, the use of turbochargers permits more complete combustion of the fuel delivered to the engine, which contributes to the highly desirable goal of a cleaner environment.

Turbochargers typically include a turbine housing connected to the engine's exhaust manifold, a center bearing housing, and a compressor housing connected to the engine's intake manifold. A turbine wheel in the turbine housing is rotatably driven by an inflow of exhaust gas supplied from the exhaust manifold. A shaft rotatably supported in the center bearing housing connects the turbine wheel to a compressor impeller in the compressor housing so that rotation of the turbine wheel causes rotation of the compressor impeller. As the compressor impeller rotates, it increases the air mass flow rate, airflow density and air pressure delivered to the engine's cylinders via the engine's intake manifold. It is often advantageous to regulate the exhaust gas flowing to the turbine wheel to improve efficiency, responsiveness or the operating range of the turbocharger.

### SUMMARY

In some aspects, a variable geometry turbine includes a turbine housing that defines a fluid inlet, a fluid outlet, and a volute that receives fluid from the fluid inlet. The turbine includes a turbine wheel disposed in the turbine housing between the volute and the fluid outlet and configured to rotate about an axis, and a radially-extending nozzle that directs fluid from the volute to the turbine wheel. The nozzle is defined between a working surface of an adjustable nozzle ring and a facing surface of the turbine housing. An inner peripheral edge of the nozzle ring is movable in an axial direction relative to an outer peripheral edge of the nozzle ring, whereby the nozzle dimensions can be varied.

The variable geometry turbine includes one or more of the following features: The nozzle ring is movable between a first configuration in which the working surface is parallel to the facing surface, and a second position in which the working surface is angled relative to the facing surface. An angle of the working surface relative to the facing surface is variable. When the working surface is angled relative to the facing surface, the nozzle axial dimension decreases from the volute to the turbine wheel. The nozzle ring is configured to be elastically deformable in a direction parallel to the axis such that the nozzle dimensions can be varied. The outer peripheral edge of the nozzle ring engages the turbine housing. The nozzle ring includes radially extending slots that extend outward from the inner peripheral edge. The nozzle ring is an annular plate and includes a body and a rim formed about the outer periphery of the body, and wherein the rim is connected to the body via a step, whereby the rim is offset relative to the body, and the slots extend from the inner peripheral edge to the step. The working surface is free of surface features. The working surface includes surface features configured to affect fluid flow paths through the nozzle. The turbine includes an actuating ring disposed on a side of the nozzle ring opposed to the working surface, and the actuating ring is configured to change the configuration of the nozzle ring. The nozzle ring includes an actuating surface that is opposed to the working surface, and the actuating surface includes nozzle ring protrusions that are configured to engage corresponding actuating ring protrusions provided on the actuating ring. The actuating ring is rotatable relative to the nozzle ring, and the nozzle ring is configured such that rotation of the actuating ring causes the actuating ring protrusions to engage with the nozzle ring protrusions in a manner such that the working surface is deflected. The nozzle ring includes an annular frame and radially-extending segments that are connected to the frame via a hinge. The segments are shaped and dimensioned so that a first side edge of one segment overlaps a second side edge of an adjacent segment.

In some aspects, an exhaust gas turbocharger includes a compressor section including a compressor wheel; a turbine section including a turbine housing and a turbine wheel disposed in the turbine housing; and a shaft that connects the compressor wheel to the turbine wheel and defines an axis. The turbine housing defines a fluid inlet, a fluid outlet, and a volute that receives fluid from the fluid inlet. The turbine wheel is disposed in the turbine housing between the volute and the fluid outlet. In addition, a radially-extending nozzle is defined between a working surface of an adjustable nozzle ring and a facing surface of the turbine housing, and the nozzle directs fluid from the volute to the turbine wheel. An inner peripheral edge of the nozzle ring is movable in an axial direction relative to an outer peripheral edge of the nozzle ring, whereby the nozzle dimensions can be varied.

In some aspects, a turbocharger turbine includes a variable nozzle. In particular, the turbine includes a nozzle that extends radially relative to a rotational axis of the turbine wheel and is defined between a nozzle assembly and a facing surface of the turbine housing. The nozzle assembly includes an annular nozzle ring, and the shape of the nozzle ring is adjustable, whereby the nozzle width can be varied. This feature permits regulation the exhaust gas flowing to the turbine wheel to improve efficiency, responsiveness or the operating range of the turbocharger independently of the engine exhaust flow rate. By varying the shape of the nozzle ring, the shape and size of the nozzle are also varied in such a way that fluid flow into the turbine wheel is uninterrupted and includes a mixed-flow component (i.e., includes an axially-directed component). The mixed flow component aids the transition of fluid flow from circumferentially-directed flow within the volute to the axially-directed flow at the exit of the turbine wheel. This nozzle configuration is advantageous relative to some conventional devices that regulate the exhaust gas flowing to the turbine wheel such as Variable Geometry Turbines (VGT).

VGT turbochargers include a plurality of adjustable guide vanes pivotally supported by a vane support ring within a wheel inlet leading to the turbine wheel. The space between adjacent guide vanes constitutes flow channels for the exhaust gas flowing to the turbine wheel and the geometry of the flow channels is adjustable by adjusting the guide vanes within a pre-determined range of angular positions between an open position and a closed position. In order to provide a high boost pressure at low engine speeds, the guide vanes are adjusted to constrict the flow channels between adjacent guide vanes. This results in the exhaust gas moving through the flow channels at a high speed. The increased kinetic energy of the exhaust gas is transferred to the turbine wheel, increasing the turbine wheel rotational speed and thus the boost pressure. At high engine speeds, the guide vanes are adjusted to open up the flow channels between adjacent guide vanes. This results in the exhaust gas impacting the turbine wheel at a lower speed, thus decreasing the turbine wheel rotational speed and thus the boost pressure.

Typical VGT guide vanes pivot or slide between a pair of vane rings which must be precisely machined and controlled to limit exhaust gas leakage. Efficiency losses in VGT systems are characterized by leakage between the guide vanes and the vane rings, boundary layer effects along the vane rings, boundary layer effects along the guide vane surfaces, and fluid flow blockage by spacers disposed between the vane rings. In addition, it can be difficult to control the clearance to the guide vanes at turbocharger operating temperatures due to thermal expansion of the materials used to form the guide vanes, vane rings, and spacers. For this reason, clearances, and therefore losses, are relatively large to ensure proper function of the VGT system, and relatively expensive materials and processes are used to form these components.

The variable nozzle including the nozzle ring advantageously creates a pressure/velocity gradient by varying the shape of the nozzle ring, and thus varying the shape and size of the diffuser nozzle, with no components permanently protruding into the fluid flow. As the variable nozzle is moved from an open position to a closed position, the nozzle not only imparts a pressure gradient, and also influences the fluid flow direction with an axial vector directed towards the turbine exit.

The variable nozzle has reduced complexity and mass as compared to some conventional VGT systems that include movable vanes. The relative reduction in complexity results in a turbocharger that is less expensive and more reliable than some conventional VGT systems. In addition, the relative reduction in mass results in improved fuel economy and a reduced thermal mass. The reduced thermal mass permits the turbocharger to come to operating temperatures in less time, which can in turn reduce engine emissions in cold start situations.

### BRIEF DESCRIPTION OF THE DRAWINGS

Advantages of the variable geometry turbine will be readily appreciated as the same becomes better understood by reference to the following detailed description when considered in connection with the accompanying drawings wherein:

FIG. 1 is a schematic view of a vehicle engine system including an engine and an exhaust gas turbocharger connected to the engine.

FIG. 2 is a partially-sectioned perspective view of the turbine section of the turbocharger of FIG. 1 showing the compressor-facing side of a nozzle assembly.

FIG. 3 is a cross-sectional view of a portion of the turbine section and bearing housing of the turbocharger of FIG. 1 showing the turbine-facing side of the nozzle assembly of FIG. 2.

FIG. 4 is a cross-sectional view of the turbine section of the turbocharger of FIG. 1 including the nozzle assembly of FIG. 2.

FIG. 5 is a partially-sectioned perspective view of the compressor-facing side of the nozzle assembly of FIG. 2.

FIG. 6 is a partially-sectioned perspective view of the turbine-facing side of the nozzle assembly of FIG. 2.

FIG. 7 is a cross-sectional view of the turbine section showing the nozzle assembly of FIG. 2 in an open position.

FIG. 8 is a cross-sectional view of the turbine section showing the nozzle assembly of FIG. 2 in a closed position.

FIG. 9 is an exploded perspective view of an alternative nozzle assembly.

FIG. 10 is a cross-sectional view of the turbine section of the turbocharger of FIG. 1 including the nozzle assembly of FIG. 9.

FIG. 11 is a cross-sectional perspective view of a portion of the turbine section showing the turbine-facing side of the nozzle assembly of FIG. 9.

FIG. 12 is a cross-sectional perspective view of a portion of the turbine section showing the compressor-facing side of the nozzle assembly of FIG. 9.

FIG. 13 is a perspective view of the compressor-facing side of another alternative nozzle ring.

FIG. 14 is a perspective view of the turbine-facing side of a nozzle assembly that includes the nozzle ring of FIG. 13.

### DETAILED DESCRIPTION

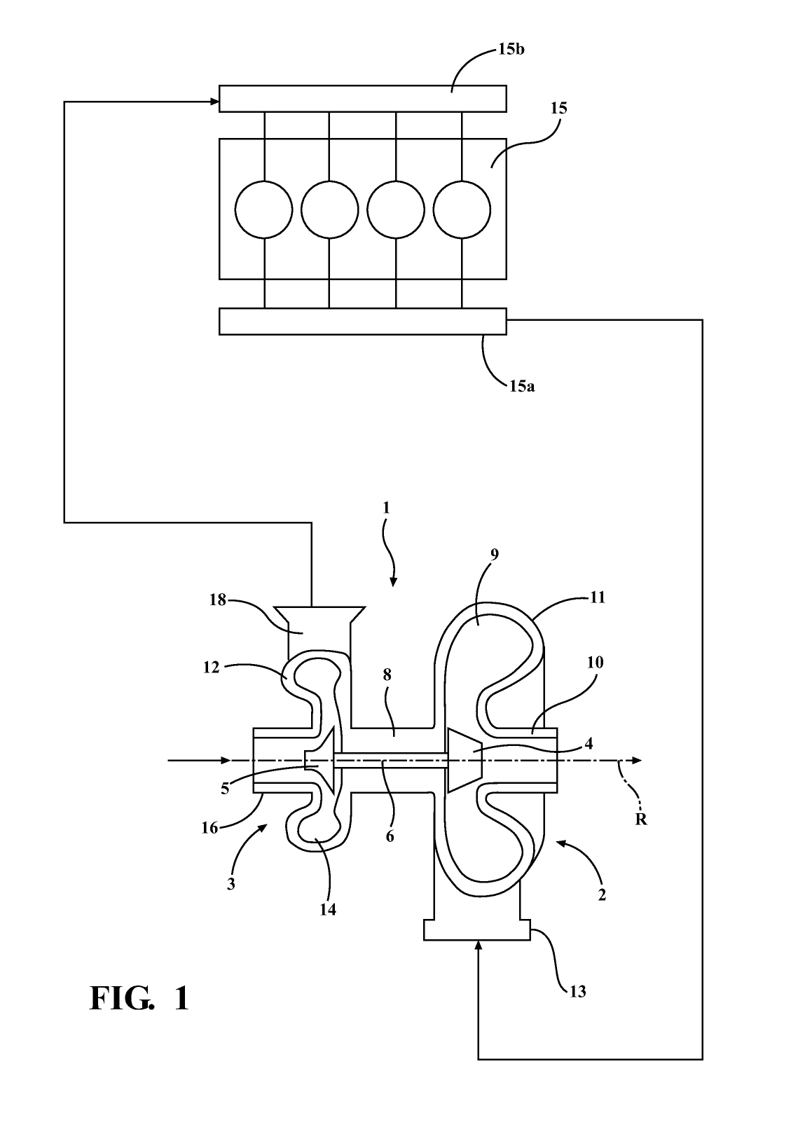

Referring to FIG. 1, an exhaust gas turbocharger 1 includes a turbine section 2, the compressor section 3, and a center bearing housing 8 disposed between and connecting the compressor section 3 to the turbine section 2. The turbine section 2 includes a turbine housing 11 that defines an exhaust gas inlet 13, an exhaust gas outlet 10, and a turbine volute 9 disposed in the fluid path between the exhaust gas inlet 13 and exhaust gas outlet 10. A mixed-flow turbine wheel 4 is disposed in the turbine housing 11 between the turbine volute 9 and the exhaust gas outlet 10.

The compressor section 3 includes a compressor housing 12 that defines the air inlet 16, an air outlet 18, and a compressor volute 14. A compressor wheel 5 is disposed in the compressor housing 12 between the air inlet 16 and the compressor volute 14. The compressor wheel 5 is connected to a shaft 6. The shaft 6 connects the turbine wheel 4 to the compressor wheel 5. The shaft 6 is supported for rotation about a rotational axis R within the bearing housing 8 via bearings (not shown).

In use, the turbine wheel 4 in the turbine housing 11 is rotatably driven by an inflow of exhaust gas supplied from the exhaust manifold 15a of an engine 15. Since the shaft 6 connects the turbine wheel 4 to the compressor wheel 5 in the compressor housing 12, the rotation of the turbine wheel 4 causes rotation of the compressor wheel 5. As the compressor wheel 5 rotates, it increases the air mass flow rate, airflow density and air pressure delivered to the engine's cylinders via an outflow from the compressor air outlet 18, which is connected to the engine's air intake manifold 15b.

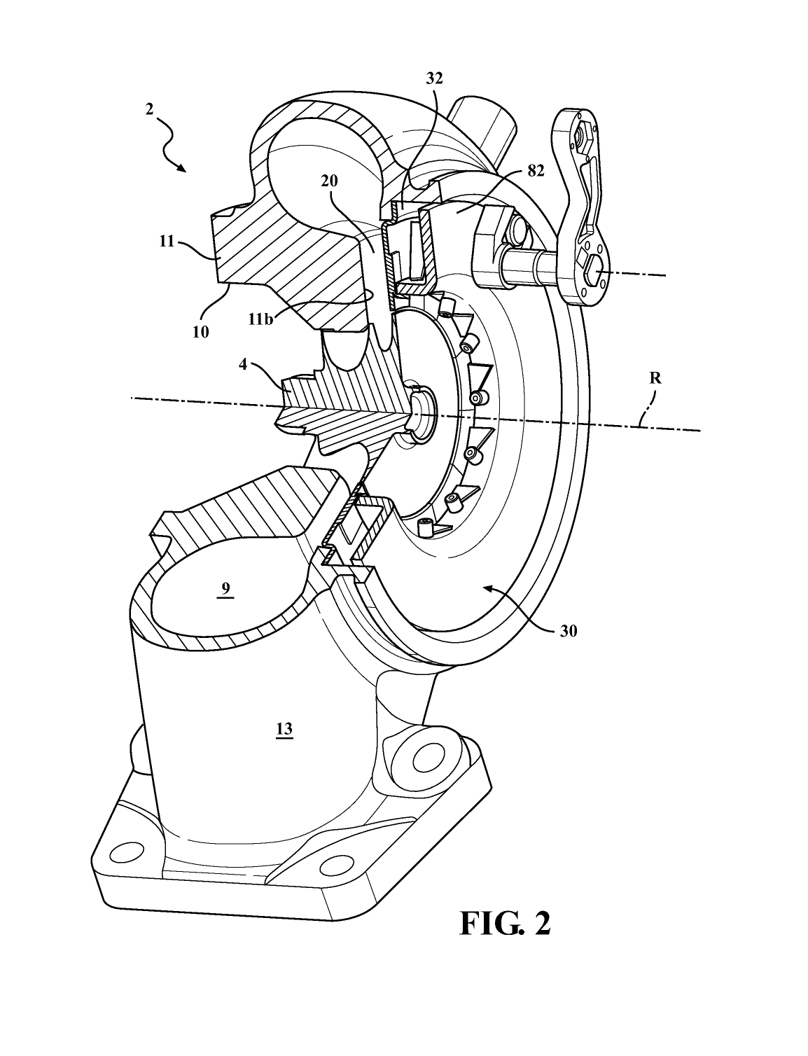

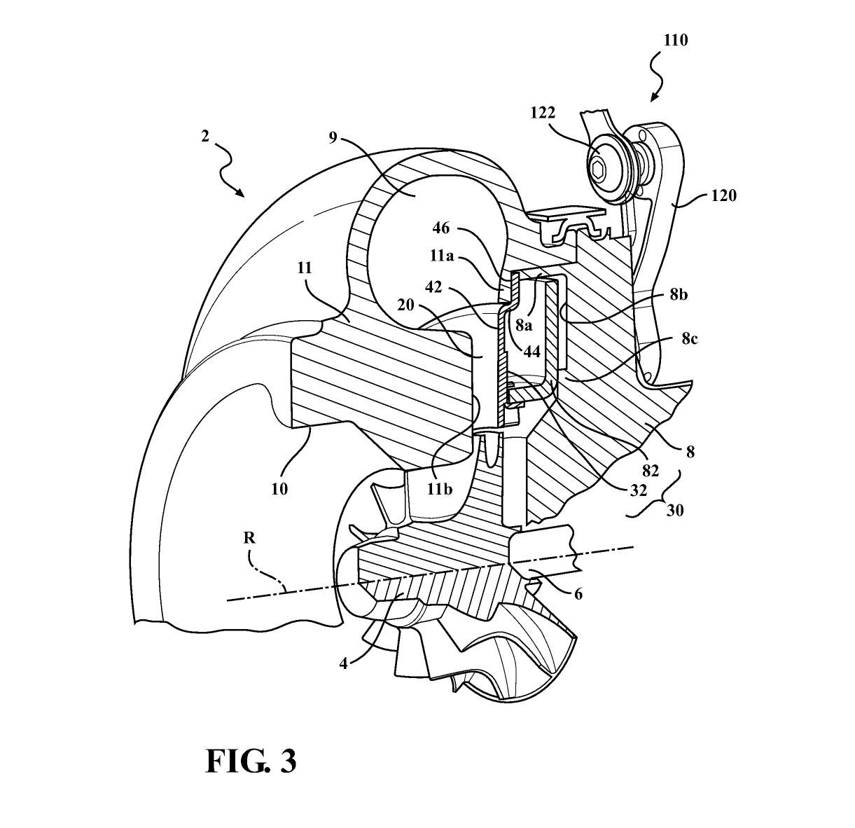

Referring to FIGS. 2 and 3, in order to maximize the efficiency of the turbocharger 1, the turbine section 2 includes a variable nozzle 20 that controls and/or regulates the exhaust gas flowing to the turbine wheel 4. The nozzle 20 is defined between a nozzle assembly 30 and a portion of the turbine housing 11 disposed between the exhaust gas outlet 10 and the turbine volute 9. As used herein, the nozzle 20 refers to a radially-extending air passageway that directs air flow from the circumferentially-extending turbine volute 9 to the turbine wheel 4.

The nozzle assembly 30 includes an annular nozzle ring 32 and an annular actuating ring 82 that is disposed parallel to, and nested with, the nozzle ring 32. The shape of the nozzle ring 32 is adjustable via the actuating ring 82, whereby the shape and axial width of the nozzle 20 can be varied, as discussed further below.

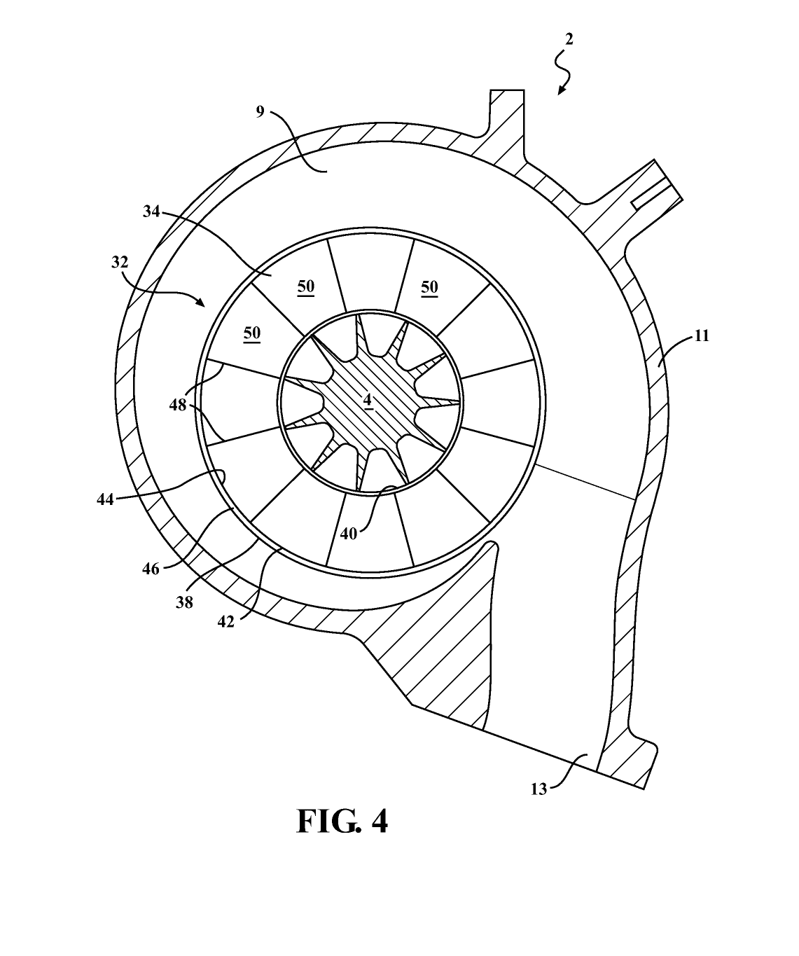

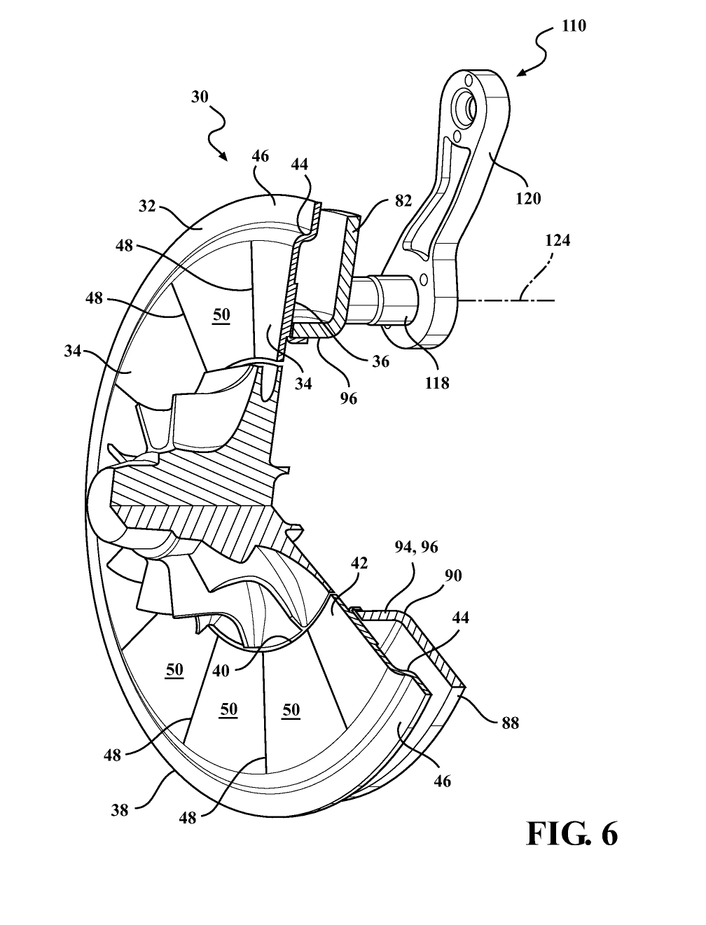

Referring also to FIGS. 4-6, the nozzle ring 32 has the form of an annular plate, and includes an inner peripheral edge 40 that faces the turbine wheel 4, an outer peripheral edge 38 that is concentric with the inner peripheral edge 40. The nozzle ring 32 includes an axially-protruding step 44 that is disposed adjacent to the outer peripheral edge 38, whereby a rim 46 is formed between the outer peripheral edge 38 and the step 44. The rim 46 is axially offset relative to a body 42, where the body 42 refers to the portion of the nozzle ring 32 between the inner peripheral edge 40 and the step 44. In addition, when the nozzle ring 32 is in an open position (discussed below), the rim 46 is parallel to the body 42 (FIG. 3). The step 44 and the rim 46 cooperate to engage a portion 11a of the turbine housing 11 on an inboard side of the turbine volute 9. In addition, the rim 46 is clamped between the turbine housing portion 11a and a flange 8a of the bearing housing 8, whereby the position of the outer peripheral edge 38 of the nozzle ring 32 is fixed relative to the turbine housing 11.

The nozzle ring 32 includes an axially outward-facing working surface 34, and an opposed, axially inward-facing actuating surface 36. The working surface 34 faces, and is axially spaced apart from, the facing surface 11b of the turbine housing 11. In addition, the working surface 34 is generally free of surface features. The nozzle ring 32 includes radially extending slots 48 that extend axially between the working surface 34 and the actuating surface 36 such that the slots 48 pass through the thickness of the body 42. In addition, the slots 48 extend radially between the inner peripheral edge 40 and the step 44. The slots 48 segregate the body 42 into discrete segments 50. The width of the slots 48 (e.g., the spacing between the segments 50) is minimized to minimize exhaust gas leakage therethrough.

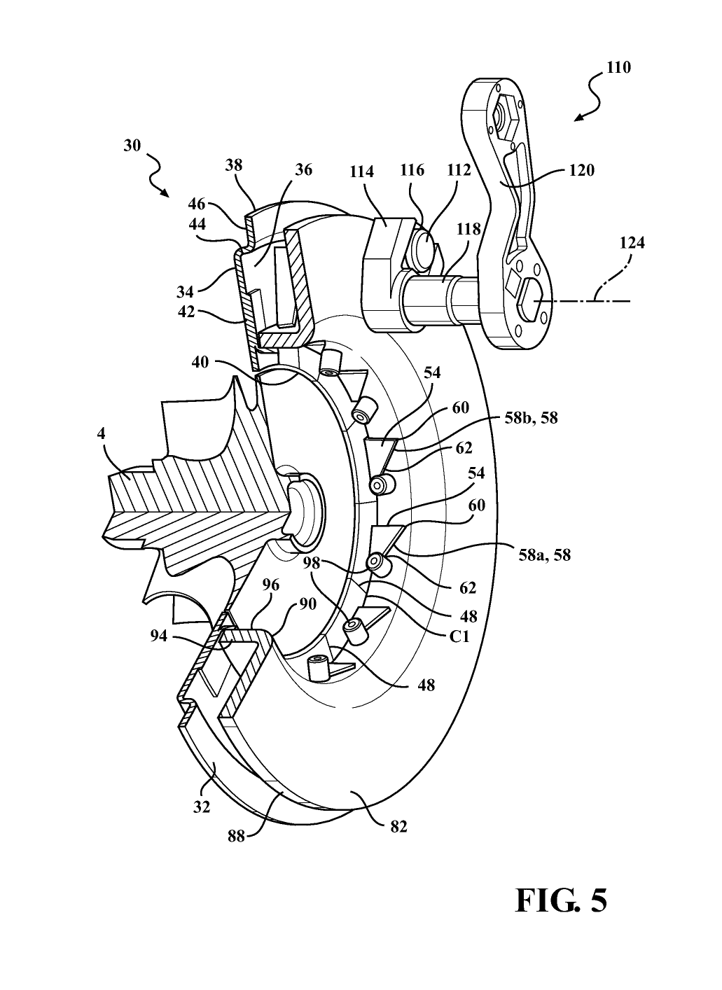

The nozzle ring actuating surface 36 faces the actuating ring 82, and includes axially-extending protrusions 54 that protrude toward the actuating ring 82 (FIG. 5). A protrusion 54 is disposed in each segment 50, and is positioned closer to the inner peripheral edge 40 than to the step 44. The free end of each protrusion 54 is angled to form a ramp 58 that cooperates with a corresponding drive pin 98 of the actuating ring 82 to change the configuration of the nozzle ring 32, as discussed further below. The protrusions 54 are arranged so that the respective ramps 58 generally lie on circle C1 that is concentric with the nozzle ring inner peripheral edge 40, with a maximum height portion 60 of a given ramp 58a facing a minimum height portion 62 of an adjacent ramp 58b.

The nozzle ring 32 may be formed, for example, by stamping, and may be formed of a spring steel or high temperature alloy such as Inconel 718. The protrusions 54 may be formed integrally with the body 42, or alternatively may be formed separately and connected to the actuating surface 36 by conventional methods such as brazing or welding.

The actuating ring 82 includes an outer peripheral edge 88, an inner peripheral edge 90 that is concentric with the outer peripheral edge 88, and an axially-extending flange 94 that is formed integrally with the inner peripheral edge 90. The actuating ring 82 also includes radially-inward protruding drive pins 98 arranged equidistantly apart about the radially-inward facing surface 96 of the flange 94. In particular, when the nozzle ring 32 is in an open position, each drive pin 98 is arranged adjacent a minimum height portion 62 of a corresponding ramp 58 of the nozzle ring 32.

Referring again to FIG. 3, the actuating ring 82 is received within a circumferential groove 8b formed in the bearing housing 8. The groove 8b is concentric with the rotational axis R, and is partially defined by the bearing housing flange 8a. The groove 8b is configured retain the actuating ring 82 in an axially layered and nested configuration relative to the nozzle ring 32. In this regard, the groove 8b includes an axially-outward protruding step 8c that abuts the actuating ring inner peripheral edge 90. The actuating ring 82 is configured to rotate within the groove 8b about the rotational axis R.

Referring to FIGS. 3 and 5, the actuating ring 82 is driven to rotate about the rotational axis R by an external actuator (not shown) via a linkage 110. The linkage 110 includes a first pin 112, a block 114, a pivot shaft 118, a pivot arm 120 and a ball joint 122. The first pin 112 protrudes axially from, and is fixed to, the actuating ring 82 adjacent the outer peripheral edge 88, and extends parallel to the rotational axis R. The block 114 is rectangular, and has an axial opening 116 at one end that rotatably receives the first pin 112. The pivot shaft 118 is arranged in parallel to the first pin 112, and has a first end that is fixed to the block 114, and an opposed, second end that is fixed to one end of the pivot arm 120. At its opposed end, the pivot arm 120 supports the ball joint 122, which in turn is connected to the actuator. In use, the actuator acts through the ball joint 122 to cause the pivot arm 120 to rotate about an axis 124 defined by the pivot shaft 118. As a result, the pivot shaft 118, and thus also the block 114, rotates about the pivot shaft axis 124. Motion of the block 114 moves the first pin 112, whereby the actuating ring 82 rotates about the rotational axis R.

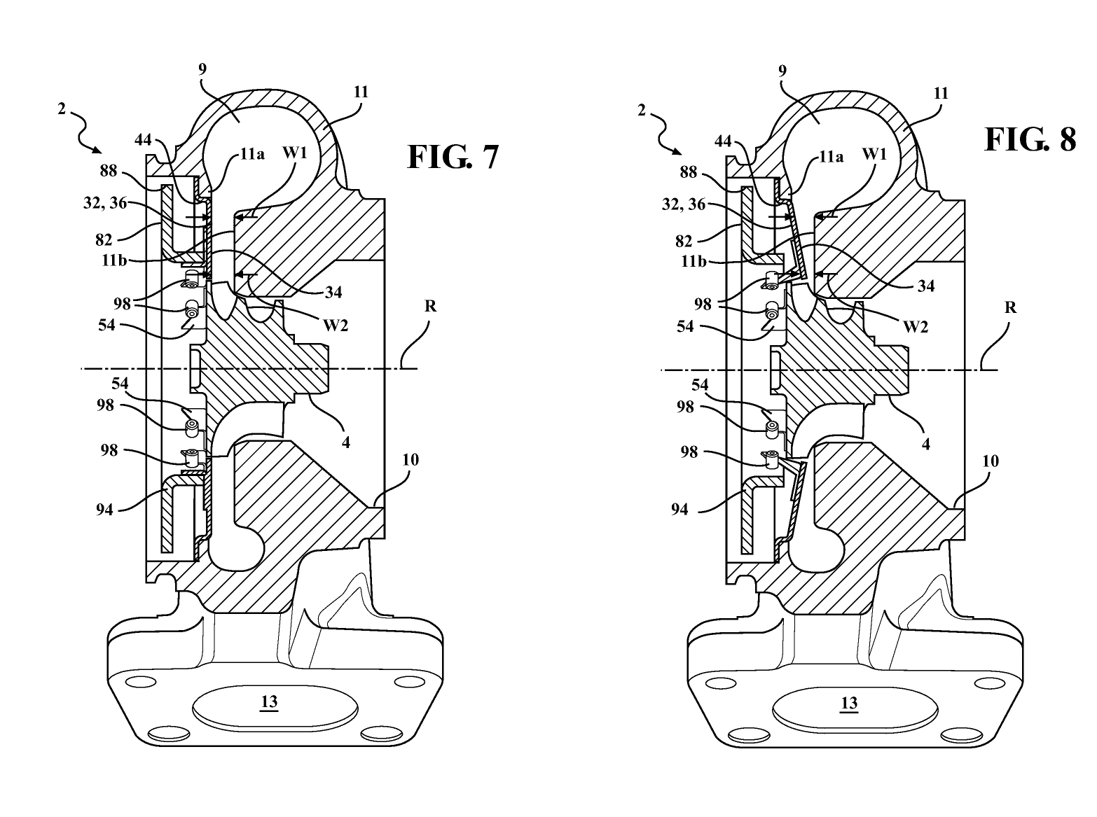

Referring to FIGS. 7 and 8, the shape and axial width of the nozzle 20 can be varied by controlling the relative positions of the nozzle ring 32 and the actuating ring 82. The rotational orientation of the nozzle ring 32 is fixed, and rotational orientation of the actuating ring 82 is controlled by the actuator. In addition, rotational movement of the actuating ring 82 causes the nozzle ring 32 to change between an “open” position in which the working surface 34 and the turbine housing facing surface 11b are parallel and the nozzle 20 has a maximum volume (FIG. 7), and a “closed” position in which a portion of the nozzle ring working surface 34 adjacent the inner peripheral edge 40 is moved closer to the turbine housing facing surface 11b (FIG. 8).

In order to move the nozzle ring 32 toward the closed position, the actuating ring 82 is rotated, which in turn moves the drive pins 98 across the surface of the corresponding ramp 58 in a direction from the minimum height portion 62 toward the maximum height portion 60. As the drive pins 98 move across the surface of the corresponding ramp 58 in a direction from the minimum height portion 62 toward the maximum height portion 60, each individual nozzle ring segment 50 is urged axially toward the turbine housing facing surface 11b. Since the position of the nozzle ring outer peripheral edge 38 is fixed, movement of the drive pins 98 across the surfaces of the corresponding ramps 58 causes the nozzle ring body 42 and inner peripheral edge 40 to elastically deform, and thus deflect axially relative to the nozzle ring outer peripheral edge 38 toward the turbine housing facing surface 11b. In particular, the nozzle ring body 42 and inner peripheral edge 40 are axially displaced into the nozzle 20. The amount of axial displacement of the segments 50 is determined by the amount of rotation of the actuating ring 82.

Displacement of the segments 50 into the nozzle 20 results in a change in the shape of the nozzle 20. In particular, the axial width of the nozzle 20 is made to radially vary such that in some configurations, the nozzle width can be made greater adjacent the nozzle ring step 44 than the nozzle width adjacent the nozzle ring inner peripheral edge 40. For example, when the nozzle ring 32 is moved toward the closed position, the axial width of the nozzle 20 radially varies such that the nozzle width w₁ is greater adjacent the nozzle ring step 44 than the nozzle width w₂ adjacent the nozzle ring inner peripheral edge 40 (FIG. 8), whereby the pressure and velocity of the exhaust gas flow through the nozzle 20 is changed (e.g., increased). This can be compared to the nozzle ring open position, in which the nozzle width w₁ adjacent the nozzle ring step 44 is substantially equal to the nozzle width w₂ adjacent the nozzle ring inner peripheral edge 40 (FIG. 7).

The shape of the working surface 34 will depend on the stiffness properties of the material used to form the nozzle ring 32. For example, use of a relatively stiff material will result in a substantially linear radial variation in nozzle width and the working surface 34 being angled relative to the turbine housing facing surface 11b when viewed in cross-section (FIG. 7), whereas use of a relatively flexible material will result in a non-linear radial variation in nozzle width and the working surface 34 having a parabolic shape when viewed in cross-section. In addition, the shape of the working surface 34 also depends on the length of the slot 48, whereby the stiffness of the nozzle ring 32 can be tuned by adjusting the slot length.

In addition, when the nozzle ring 32 is moved toward the closed position, the direction of the exhaust gas flow through the nozzle 20 is changed by the shape of the nozzle ring 32 from a solely radial flow direction to a flow direction that includes both a radial component and an axial component. This mixed-direction exhaust gas flow aids the transition of the exhaust gas flow from radial flow to axial flow as it passes over the turbine wheel 4.

The nozzle assembly 30 including the nozzle ring 32 and actuating ring 82 thus permits control of the speed of the turbocharger 1 substantially independently of the engine exhaust flow rate. This is accomplished without insertion of flow-directing vanes into the exhaust gas flow path which may be associated with efficiency losses due to exhaust gas leakage, vane boundary layer effects, and gas flow blockage. In addition, due to its relatively simple structure, the nozzle ring 32 can more easily accommodate thermal growth and distortion that can occur at turbocharger operating temperatures than some conventional vanes, which require sufficient clearances to ensure proper vane pivoting function despite thermal growth, and thus introduce additional losses into the system.

When the actuator drives the actuating ring 82 to move the nozzle ring 32 toward the open position, rotation of the actuating ring 82 moves the drive pins 98 across the surface of the corresponding ramp 58 in a direction from the maximum height portion 60 toward the minimum height portion 62. As a result, due to the resilient properties of the material used to form the nozzle ring 32, each individual nozzle ring segment 50 returns to its unloaded configuration. Specifically, the nozzle ring body 42 and inner peripheral edge 40 retract from the nozzle 20 and move axially toward the actuating ring 82. In addition, the reaction force due to material elasticity that urges the segments 50 to return to the unloaded configuration may be aided by the pressure of the exhaust gas flow through the nozzle 20.

Because the nozzle ring 32 can be refracted from the nozzle 20, there are operating conditions in which there are minimal or no obstructions to exhaust gas flow within the nozzle 20. This is advantageous relative to some VGT systems in which the guide vanes remain in the exhaust gas flow path regardless of the operating position of the guide vanes.

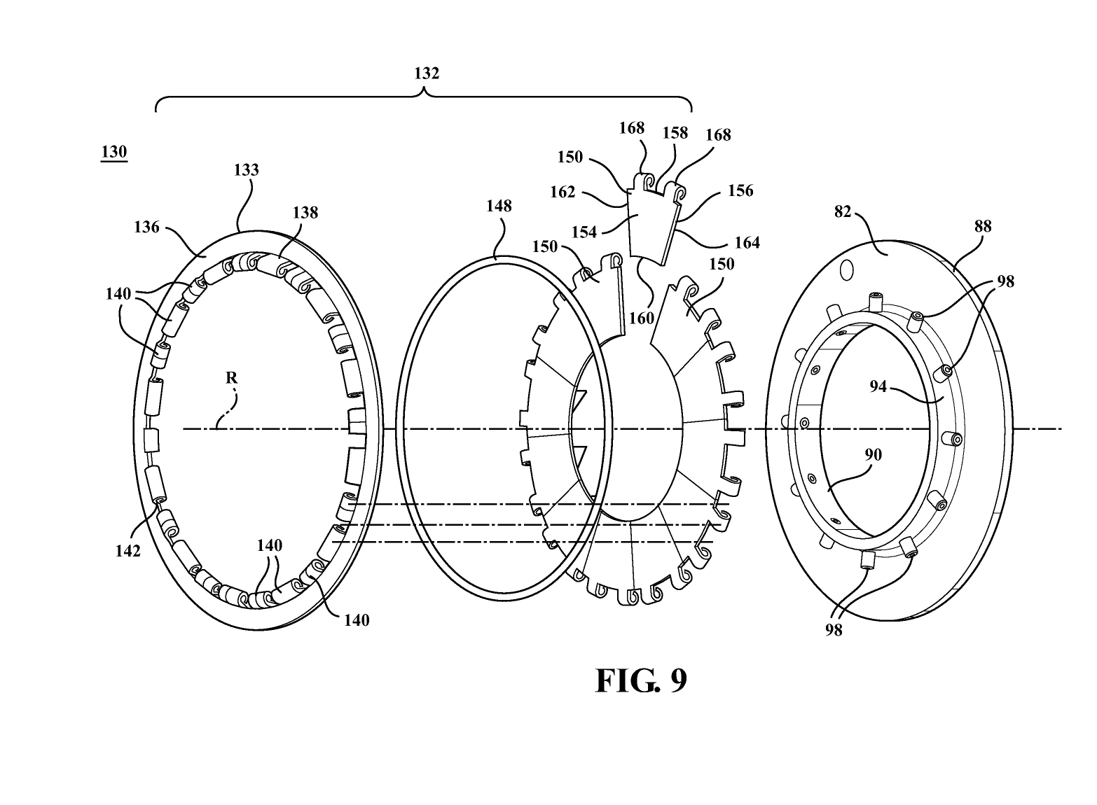

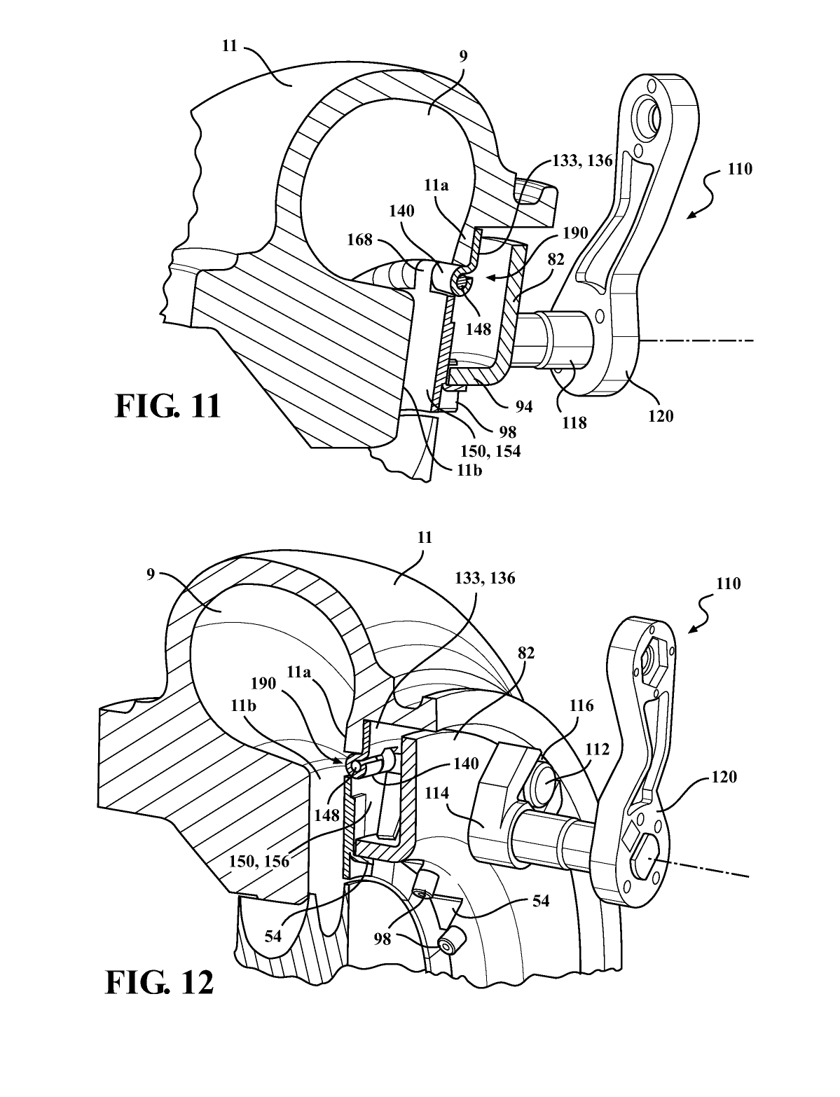

Referring to FIGS. 9-12, an alternative embodiment nozzle assembly 130 for use in the turbocharger 1 includes an annular nozzle ring 132 and the above-described annular actuating ring 82. As in the previous embodiment, the actuating ring 82 is disposed parallel to, and nested with, the nozzle ring 132. In addition, the shape of the nozzle ring 132 is adjustable via the actuating ring 82, whereby the shape and axial width of the nozzle 20 can be varied, as discussed further below. The nozzle ring 132 differs from the previously-described nozzle ring 32 in that the nozzle ring 132 includes segments 150 that are formed individually, and each individual segment 150 is connected to an annular frame 133 via a hinge 190.

In this regard, the nozzle ring 132 includes the annular frame 133, the segments 150, and a wire loop 148 that serves as the hinge pin for each segment 150. The frame 133 includes a radially extending portion that defines a rim 136. When assembled in the turbocharger 1, the rim 136 is clamped between the turbine housing portion 11a and the flange 8a of the bearing housing 8, whereby the position of the annular frame 133 is fixed relative to the turbine housing 11.

An inner peripheral edge 142 of the rim 136 includes a step 138 that extends axially and terminates in circumferentially-spaced rim knuckles 140. In some embodiments, the rim knuckles 140 are formed by folding portions of the step 138 back on itself.

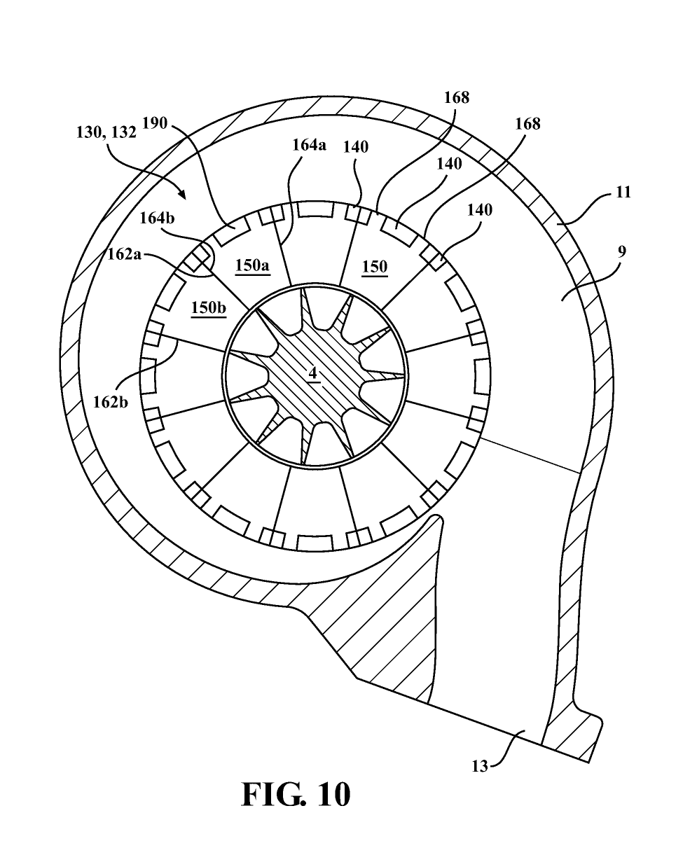

Each segment 150 is a flat plate, and when seen in top plan view (FIG. 10), has a profile in the shape of a sector of an annulus. As a result, each segment 150 includes a curved outer peripheral edge 158, and a curved inner peripheral edge 160 that is concentric with the outer peripheral edge 158. The outer and inner peripheral edges 158, 160 are connected by opposed side edges 162, 164 that are angled so that the circumferential length of the outer peripheral edge 158 is greater than the circumferential length of the inner peripheral edge 160. The outer peripheral edge 158 includes circumferentially-spaced segment knuckles 168. In some embodiments, the segment knuckles 168 are formed by folding portions of the outer peripheral edge 158 back on itself.

Each segment 150 includes an axially outward-facing segment working surface 154, and an opposed, axially inward-facing segment actuating surface 156. The segment working surface 154 faces, and is axially spaced apart from, the facing surface 11b of the turbine housing 11. In addition, the segment working surface 154 is generally free of surface features. The segment actuating surface 156 faces the actuating ring 82, and includes an axially-extending protrusion 54 that protrudes toward the actuating ring 82. The protrusion 54 is positioned closer to the inner peripheral edge 160 than to the outer peripheral edge 158. As in the previous embodiment, the free end of each protrusion 54 is angled to form a ramp 58 that cooperates with a corresponding pin 98 of the actuating ring 82 to change the configuration of the nozzle ring 32. When the segments 150 are assembled with the frame 133, the protrusions 54 are arranged so that the respective ramps 58 generally lie on a circle (not shown) that is concentric with the segment inner peripheral edge 160, with a maximum height portion 60 of a given ramp 58a facing a minimum height portion 62 of an adjacent ramp 58b.

In the nozzle ring 132, the segments 150 are arranged about the rim inner peripheral edge 142 so that a first side edge 162a of one segment 150a abuts the second side edge 164b of an adjacent segment 150b (FIG. 10). In addition, the rim knuckles 140 are interspersed, and circumferentially aligned, with the segment knuckles 168 of each segment 150. The segments 150 are connected to the rim 136 of the frame 133 via the wire loop 148, which extends through each respective rim knuckle 140 and each respective segment knuckle 168. The wire loop 148, the rim knuckles 140 and the segment knuckles 168 cooperate to form the hinge 190, whereby the segments 150 can rotate relative to the rim 136 about an axis defined by the wire loop 148.

The shape and axial width of the nozzle 20 can be varied by controlling the relative positions of the nozzle ring 132 and the actuating ring 82. The rotational orientation of the nozzle ring 132 is fixed, and rotational orientation of the actuating ring 82 is controlled by the actuator as described above. Thus, rotational movement of the actuating ring 82 causes the nozzle ring 132 to change between an “open” position in which the working surface 134 and the turbine housing facing surface 11b are parallel and the nozzle 20 has a maximum volume, and a “closed” position in which a portion of the nozzle ring working surface 134 adjacent the inner peripheral edge 40 is moved closer to the turbine housing facing surface 11b, as a result of movement of the actuating ring 82.

When the actuator drives the actuating ring 82 to move the nozzle ring 132 toward the closed position, rotation of the actuating ring 82 moves the drive pins 98 across the surface of the corresponding ramp 58 in a direction from the minimum height portion 62 toward the maximum height portion 60. As the drive pins 98 move across the surface of the corresponding ramp 58 in a direction from the minimum height portion 62 toward the maximum height portion 60, each individual nozzle ring segment 150 is urged axially toward the turbine housing facing surface 11b. Since the position of the nozzle ring frame 133 is fixed, movement of the drive pins 98 across the surfaces of the corresponding ramps 58 causes the segments 150 to pivot about the wire loop 148. In particular, the inner peripheral edge 160 of each segment 150 is axially displaced into the nozzle 20. The amount of axial displacement of the segments inner peripheral edge 160 is determined by the amount of rotation of the actuating ring 82. Displacement of the segments 150 into the nozzle 20 results in a change in the shape of the nozzle 20.

When the actuator drives the actuating ring 82 to move the nozzle ring 132 toward the open position, rotation of the actuating ring 82 moves the drive pins 98 across the surface of the corresponding ramp 58 in a direction from the maximum height portion 60 toward the minimum height portion 62, the pressure of the exhaust gas flow through the nozzle 20 urges the segments 150 to return to the unloaded configuration. In some embodiments, a spring (not shown) may also be provided to the nozzle assembly 30 to urge the segments 150 to return to the unloaded configuration.

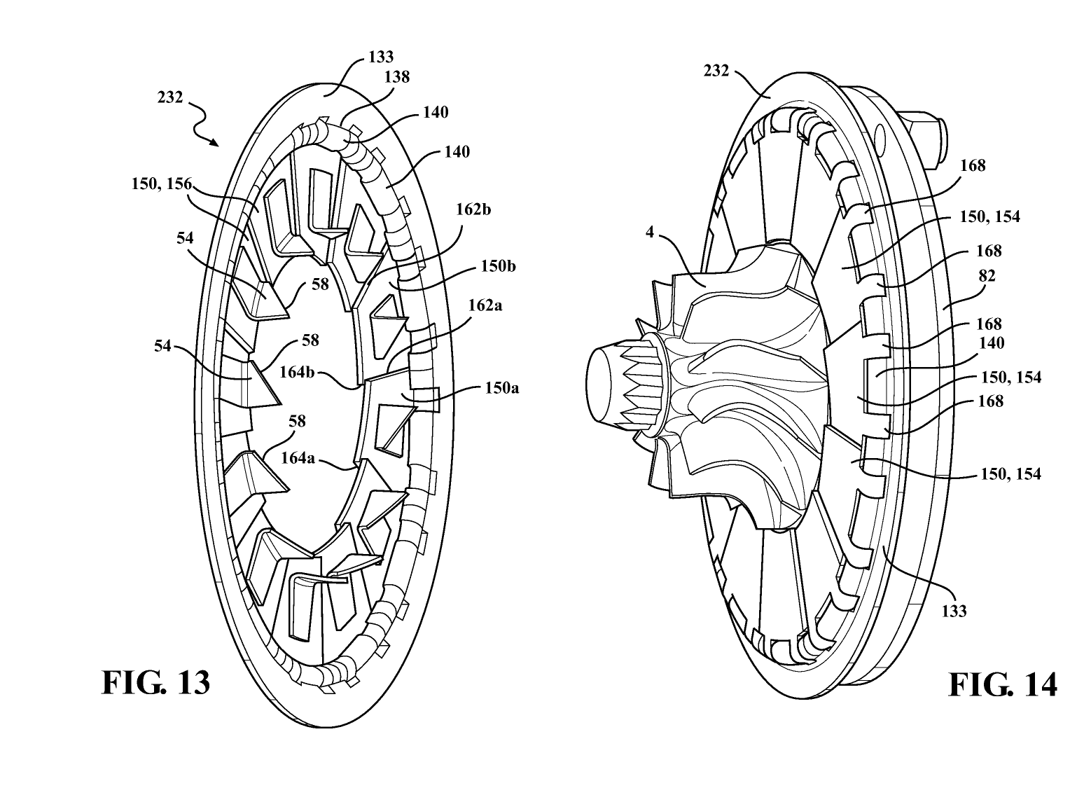

Referring to FIGS. 13-14, in an alternative nozzle ring 232, the profile of the segments 150 is shaped and dimensioned so that the first side edge 162a of a given segment 150a overlaps the second side edge 164b of an adjacent segment 150b in the manner of an iris diaphragm. The amount of overlap is sufficient that the overlap exists regardless of whether the nozzle ring 132 is in an open position or a closed position. By providing the annular nozzle ring 232 with overlapping segments 150, exhaust gas leakage between adjacent segments 150a, 150b can be minimized. Although in the illustrated embodiment, the segments 150 are arranged to overlap in an iris diaphragm configuration, the nozzle ring 232 is not limited to this overlap arrangement. For example, in some embodiments, adjacent segments 150 may be arranged to alternate between an axially outboard position and an axially inboard position.

Although the variable nozzle 20 described above is used to direct fluid to a mixed-flow type turbine wheel 4, other types of turbine wheels can be used with the variable nozzle 20. For example, in some embodiments, the turbine section 2 can include a radial flow turbine wheel. In this regard, by using the nozzle assembly 30, 130 including the elastically deformable nozzle ring 32, 132, 232 a mixed flow of exhaust gas is directed into the turbine wheel 4, whereby a turbocharger that included a radial flow turbine wheel would provide advantages similar to that of one using a mixed-flow turbine wheel.

Although the nozzle ring 32 includes slots 48 that extend between the inner peripheral edge 40 to the step 44, the slots 48 are not limited to this configuration, and may be used to tune the stiffness properties of the nozzle ring 32. For example, the slots 48 are configured to intercept the inner peripheral edge 40 and extend radially outward in a range of 30 to 100 percent of the radial distance between the inner peripheral edge 40 and the step 44.

Although the nozzle ring working surface 34 is described above as being free of surface features, the nozzle ring working surface 34 is not limited to this configuration. For example, in some embodiments, the working surface 34 includes surface features configured to influence rotational movement or to straighten fluid flow through the turbine nozzle. The surface features may include, but are not limited to, grooves or ridges.

Although the actuating ring 82 includes the drive pins 98 that are fixed to the radially-inward facing surface 96 of the flange 94 via welding, brazing, press-fit or other methods, the actuating ring 82 is not limited to using drive pins 98, and other structures may be provided to deflect the nozzle ring protrusions 54. In one example, cam followers may be used instead of the drive pins 98. In another example, the flange 94 could be formed having deflected teeth that are integral with the actuating ring 82 and configured to engage the nozzle ring protrusions 54 during rotation of the actuating ring 82.

The linkage 110 has been described herein as including a particular arrangement of the first pin 112, the block 114, the pivot shaft 118, the pivot arm 120 and the ball joint 122. However, the linkage 110 is not limited to this configuration, and may be of any configuration and/or combination of linking elements and joints that transmit the motion of the actuator to the actuating ring 82.

In the embodiment illustrated above with respect to FIGS. 2-8, when the rotation of the actuating ring 82 moves the drive pins 98 across the surface of the corresponding ramp 58 in a direction from the maximum height portion 60 toward the minimum height portion 62, each individual nozzle ring segment 50 returns to its unloaded configuration due to the resilient properties of the material used to form the nozzle ring 32. However, in other embodiments, the nozzle ring 32 may include features that permit active retraction of the segment 50 to the unloaded configuration. For example, the protrusion 54 may include an angled slot rather than the ramp 58, and the drive pin 98 may be fully captured within the slot, whereby the drive pin 98 can drive the segment 50 in both axially outward and inward directions, depending on the direction of rotation of the actuating ring 82. These features can also be incorporated in the embodiments shown in FIGS. 9-12 and FIGS. 13-14.

The variable nozzle 20 including the nozzle assembly 30 has been described herein with respect to use in the exhaust gas turbocharger 1, but is not limited to this application. For example, the variable nozzle 20 including the nozzle assembly 30 may be used in other types of turbochargers, in other systems that include turbines such as, but not limited to, Rankine Cycle systems, and in non-automotive applications including, but not limited to, those in heavy industry.

Although particular preferred embodiments of the invention have been disclosed in detail for illustrative purposes, it will be recognized that variations or modifications of the disclosed apparatus, including the rearrangement of parts, may be made without departing from the spirit and scope of the disclosure. Accordingly, other embodiments are within the scope of the following claims.

1. A variable geometry turbine, comprising
a turbine housing that defines a fluid inlet, a fluid outlet, and a volute that receives fluid from the fluid inlet;
a turbine wheel disposed in the turbine housing between the volute and the fluid outlet and configured to rotate about an axis, and
a radially-extending nozzle that directs fluid from the volute to the turbine wheel, the nozzle defined between a working surface of an adjustable nozzle ring and a facing surface of the turbine housing,
wherein an inner peripheral edge of the nozzle ring is movable in an axial direction relative to an outer peripheral edge of the nozzle ring, whereby the nozzle dimensions can be varied.

2. The variable geometry turbine of claim 1, wherein the nozzle ring is movable between a first configuration in which the working surface is parallel to the facing surface, and a second position in which the working surface is angled relative to the facing surface.

3. The variable geometry turbine of claim 1, wherein an angle of the working surface relative to the facing surface is variable.

4. The variable geometry turbine of claim 1, wherein when the working surface is angled relative to the facing surface, the nozzle axial dimension decreases from the volute to the turbine wheel.

5. The variable geometry turbine of claim 1, wherein the nozzle ring is configured to be elastically deformable in a direction parallel to the axis such that the nozzle dimensions can be varied.

6. The variable geometry turbine of claim 1, wherein the outer peripheral edge of the nozzle ring engages the turbine housing.

7. The variable geometry turbine of claim 1, wherein the nozzle ring includes radially extending slots that extend outward from the inner peripheral edge.

8. The variable geometry turbine of claim 7, wherein the nozzle ring is an annular plate and includes a body and a rim formed about the outer periphery of the body, and wherein the rim is connected to the body via a step, whereby the rim is offset relative to the body, and
the slots extend from the inner peripheral edge to the step.

9. The variable geometry turbine of claim 1, wherein the working surface is free of surface features.

10. The variable geometry turbine of claim 1, wherein the working surface includes surface features configured to affect fluid flow paths through the nozzle.

11. The variable geometry turbine of claim 1, comprising an actuating ring disposed on a side of the nozzle ring opposed to the working surface, the actuating ring configured to change the configuration of the nozzle ring.

12. The variable geometry turbine of claim 11, wherein the nozzle ring includes an actuating surface that is opposed to the working surface, the actuating surface including nozzle ring protrusions that are configured to engage corresponding actuating ring protrusions provided on the actuating ring,
the actuating ring is rotatable relative to the nozzle ring, and
the nozzle ring is configured such that rotation of the actuating ring causes the actuating ring protrusions to engage with the nozzle ring protrusions in a manner such that the working surface is deflected.

13. The variable geometry turbine of claim 1, wherein the nozzle ring includes an annular frame and radially-extending segments that are connected to the frame via a hinge.

14. The variable geometry turbine of claim 13, wherein the segments are shaped and dimensioned so that a first side edge of one segment overlaps a second side edge of an adjacent segment.

15. An exhaust gas turbocharger, comprising:
a compressor section including a compressor wheel;
a turbine section including a turbine housing and a turbine wheel disposed in the turbine housing; and
a shaft that connects the compressor wheel to the turbine wheel and defines an axis;
wherein
the turbine housing defines a fluid inlet, a fluid outlet, and a volute that receives fluid from the fluid inlet;
the turbine wheel is disposed in the turbine housing between the volute and the fluid outlet, and
a radially-extending nozzle is defined between a working surface of an adjustable nozzle ring and a facing surface of the turbine housing, the nozzle directing fluid from the volute to the turbine wheel, and
an inner peripheral edge of the nozzle ring is movable in an axial direction relative to an outer peripheral edge of the nozzle ring, whereby the nozzle dimensions can be varied.
